(19) United States
(12) Patent Application Publication
(10) Pub. No.: US 2012/0312607 A1
(43) Pub. Date: Dec. 13, 2012

(54) Mine Resistant Armored Vehicle

(75) Inventors: Vernon P. JOYNT, Pretoria (ZA); James E. White, Summerville, SC (US); Keith T. Williams, Charleston, SC (US); Kevin A. Babb, Abbeville, SC (US)

(73) Assignee: Force Protection Technologies, Inc.

(21) Appl. No.: 12/833,811

(22) Filed: Jul. 9, 2010

Related U.S. Application Data
(60) Provisional application No. 61/272,136, filed on Aug. 20, 2009.

(51) Int. Cl. F41H 7/00; B60G 9/00; F01P 3/20; B60K 5/00

(52) U.S. Cl. 180/54.1; 89/36.02; 280/124.1; 89/903; 89/930

(57) ABSTRACT

The present disclosure is directed to a blast-resistant armored land vehicle configured to operate on a surface. The vehicle may include a body comprised of sheet materials, the body having a centerline and a bottom portion. The vehicle may further include a grid portion suspended below the bottom portion, the grid portion including one or more slats on each side of the centerline, wherein the one or more slats are oriented at an angle less than 90 degrees relative to the surface. Alternatively, the grid portion may include one or more vanes, each of the one of more vanes defining a V, with the apex of the V being rounded and directed towards the bottom portion.

### CROSS REFERENCE TO RELATED APPLICATION

This application claims the benefit of U.S. Provisional Application No. 61/272,136, filed Aug. 20, 2009, which is herein incorporated by reference in its entirety.

### FIELD OF THE INVENTION

The present invention relates to an armored motor vehicle, specifically one that has improved resistance to land mines and improvised explosive devices deployed on the path of the motor vehicle.

### BACKGROUND OF THE INVENTION

Conventional armored motor vehicles attempt to moderate the effect of mines and explosive devices by using armor of a thickness that will not be penetrated by penatrators, soil, rocks or the like, or by the blast from such a mine or explosive device. Such vehicles generally have bottom surfaces parallel to the surface on which they ride and side surfaces perpendicular to the surface on which they ride. Some vehicles may have bottom surfaces at an angle or a combination of angles, such as, for example, a single 120 degree angle, a single 60 degree angle, or a compound angle.

Traditional theory suggests that the blast energy of a mine, specifically a shaped mine, is directed upwards from the mine in conical shape. Specifically, the traditional theory states that the high pressure explosive gasses accelerate the soil or sand under which it is buried upwards (see Fig. A). This accelerated soil or sand can be referred to as “ejecta.” However, new research suggests that when a traditional mine is buried beneath the ground, the shockwave generated by the explosives results in a cylindrical column of ejecta on either side, and ahead of, of an upward column of expanding gas (see Fig. B). These columns typically have less than a 5 degree deviation in any direction. Because the traditional theory relies on the concept of a conical shaped upward blast, conventional mine protected vehicles have been designed with a relatively higher ground clearance to allow more of the blast energy to dissipate in the space above the ground before encountering the bottom of the vehicle. However, because very little energy dissipates from the soil ejecta before it contacts the vehicle, the higher ground clearance has little if any effect. Therefore, a high ground clearance may only serve to raise the center of gravity of the vehicle.

When an anti-vehicle mine detonates below a traditional vehicle, a penetrator and/or debris above the mine is propelled upward. If the bottom of the vehicle is flat and parallel to the ground, much of the energy of the mine and any material propelled by it may hit the bottom surface perpendicular to its surface. As a result, the energy of the material and the blast is most efficiently transferred to that surface and the probability that the armor bottom will be defeated and breached is maximized. Additionally, the energy of the material and the blast being transferred to that surface may cause the vehicle itself to be propelled upward, and in some cases, leave the surface on which the vehicle runs.

If the bottom of the vehicle is not flat, e.g. has a V shape, energy and blast material impulses may be less efficiently transferred to the body of the vehicle. One such example of this is U.S. Pat. No. 7,357,062 to Joynt (“the '062 patent”). The '062 patent discloses a mine resistant armored vehicle with a V-shaped bottom portion of the body, and with the included angle of the V between about 115 and 130 degrees. While this V-shaped bottom portion may help reduce the transfer of blast energy to the body of the vehicle, sharper angles, i.e. less than 90 degrees, may be even more effective considering ejecta columns that launch almost straight upwards. However, as the angle of the V-shaped bottom decreases, vehicles that require wide upper cabins may have to have a higher ride height in order to maintain a minimum operational ground clearance. Further improvements may be made to take advantage of sharper angle vehicle portions, lower ride height, and minimum operation ground clearance.

### SUMMARY OF THE INVENTION

In one aspect, the present disclosure is directed to a blast-resistant armored land vehicle configured to operate on a surface. The vehicle may include a body comprised of sheet materials, the body having a centerline and a bottom portion. The vehicle may further include a grid portion suspended below the bottom portion, the grid portion including one or more slats on each side of the centerline, wherein the one or more slats are oriented at an angle less than 90 degrees relative to the surface.

In another aspect, the present disclosure is directed to a blast-resistant armored land vehicle configured to operate on a surface. The vehicle may include a body comprised of sheet materials, the body having a centerline and a bottom portion. The vehicle may further include a grid portion suspended below the bottom portion, the grid portion including one or more vanes, each of the one of more vanes defining a V, with the apex of the V being rounded and directed towards the bottom portion.

Additional advantages of the invention will be set forth in part in the description which follows, and in part will be obvious from the description, or may be learned by practice of the invention. One or more of the advantages the invention may be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

Figure A depicts the traditional theory of buried mine explosion.

Figure B depicts the current observed theory of buried mine explosion.

FIG. 1 is a perspective view of one embodiment of the present invention;

FIG. 2 is a schematic rear view depicting one configuration of a portion of the vehicle shown in FIG. 1;

FIG. 3 is a schematic cross-sectional view of a bottom portion of the vehicle shown in FIG. 2;

FIG. 4 is a schematic cross-sectional view of an alternative bottom portion of the vehicle shown in FIG. 2;

FIG. 5 is a schematic cross-sectional view of an alternative embodiment of the bottom portion shown in FIG. 4;

FIG. 6 is a schematic cross-sectional view of an another embodiment of the bottom portion shown in FIG. 4;

FIG. 7 is a schematic rear view depicting a second configuration of a portion of the vehicle shown in FIG. 1 comprising another embodiment of the present invention;

FIG. 8 is a schematic rear view depicting a third configuration of a portion of the vehicle shown in FIG. 1 comprising another embodiment of the present invention;

FIG. 9 is a schematic bottom view depicting a fourth configuration of a portion of the vehicle shown in FIG. 1 comprising another embodiment of the present invention;

FIG. 10 is a schematic side view depicting the fourth configuration of the portion of the vehicle shown in FIG. 9; and

FIG. 11 is a schematic rear view depicting another configuration of a portion of the vehicle shown in FIG. 1.

### DESCRIPTION OF THE EMBODIMENTS

Reference will now be made in detail to the present embodiments of the invention, examples of which are illustrated in the accompanying drawings. Wherever possible, the same reference numbers will be used throughout the drawings to refer to the same or like parts.

In accordance with the invention, there is provided a blast-resistant armored land vehicle that may include a monocoque body comprised of sheet material. Alternatively, the vehicle may include body comprised of sheet material on a rigid frame. It is further contemplated that the vehicle may include a body comprised of thick armor plating in lieu of, or in addition to, sheet material. In the context of the present invention the phrase “blast-resistant” means that the vehicle is particularly resistant to penetration by either the blast energy or material propelled by the blast energy from a land mine that explodes beneath the vehicle. In the context of the present invention the phrase “land vehicle” means a vehicle intended primarily to propel itself on the surface of the ground. In the context of the present invention the word “monocoque” means a shell of sheet material joined with either welds, adhesives, fasteners, or combinations thereof to form a vehicle body that is structurally robust enough to eliminate the need for a separate load-bearing vehicle frame on which a body, engine, and drive train would normally be attached. In the context of the present invention, the word “adhesive” means material that strengthens after its initial application to join two solid pieces. Such a material can be a conventional adhesive (a liquid that solidifies or cross-links to bond materials in contact therewith).

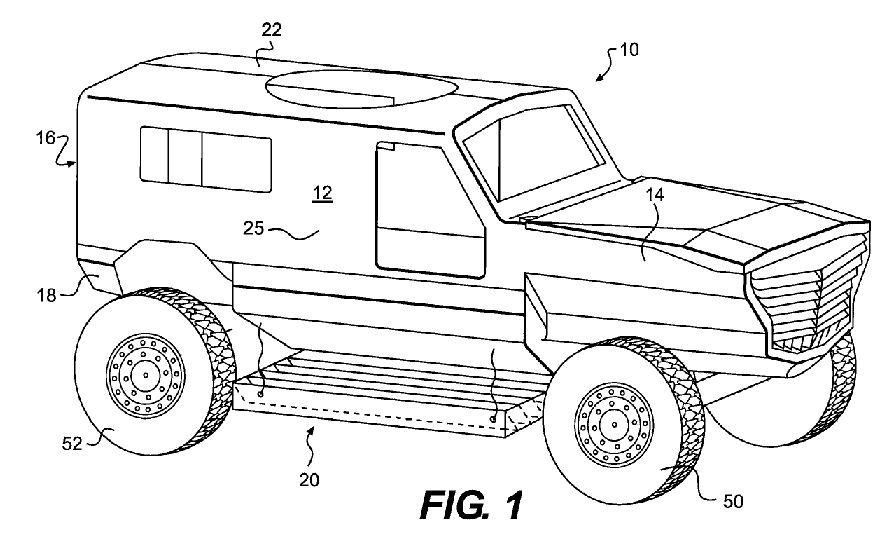

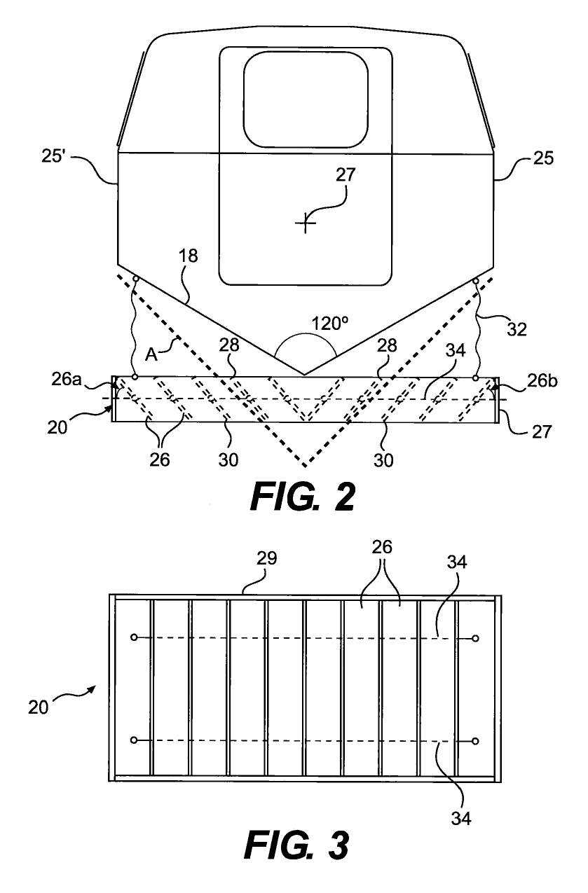

As here embodied, and depicted in FIGS. 1 and 2, a vehicle 10 may include a body 12 formed of sheet materials with a front end 14, a rear end 16, a bottom portion 18, a top portion 22, a right side portion 25, a left side portion 25′, and a centerline 27 along the front-to-rear axis of the vehicle 10 approximately half way between the right and left sides of the vehicle.

As broadly embodied in FIG. 1, vehicle 10 may further include a set of front wheels 50 and rear wheels 52. While the embodiment depicted is a 4×4 (4 wheels total×4 wheels driven), the present invention is not limited thereto. The invention can be used in a 6×6 configuration, or any number or combination of driven and/or non-driven wheels. The invention may also be used for vehicles driven by tracks, or a combination of wheels and tracks.

Vehicle 10 may include grid 20. Grid 20 may include plurality of slats 26 spaced from bottom portion 18. Grid 20 may also include a frame 29. Frame 29 is depicted in FIG. 3 as enclosing four sides of grid 20, however, it is contemplated that frame 29 may enclose less than four sides, or, alternatively, frame 29 may be omitted. Frame 29 may connect plurality of slats 26 to each other and may further serve to connect grid 20 to bottom portion 18. Grid 20 may interrupt the trajectory of the soil ejecta as well as blast energy. When the soil ejecta contacts grid 20, the speed of the debris may be slowed and deflected and any debris that penetrates grid 20 may cause less harm to bottom portion 18. Additionally, a mine blast may cause grid 20 to deform and/or otherwise move. While the deformation of grid 20 may be sufficient to cause grid 20 to contact bottom portion 18, the contact may cause little or no harm to bottom portion 18. The thickness and weight of grid 20 must be sufficient to slow the soil ejecta and blast energy, and the thickness and weight of bottom portion 18 must be sufficient to withstand contact with the slowed soil ejecta and any deformation of grid 20. Each slat 26 may be sized and oriented at an angle such that a top portion 28 is in line with, or overlaps, a bottom portion 30 of the subsequent slat 26. In this manner, the portion of bottom portion 18 that grid 20 covers is shielded from direct contact with any soil ejecta. Each slat may include a single material or combination of materials, including, but not limited to, fiber reinforced rubber, reinforced plastic, molded polyurethane, composites, metal, and metal alloy. The material used may be dependent on the anticipated threat and level of threat.

As depicted in FIG. 2, grid 20 may be suspended from bottom portion 18 by a chain or rope 32. Rope 32 may preferably be a metal chain or wire rope, but is not limited as such and may be any rope or chain known in the art, such as, for example, natural fiber, synthetic fiber, metallic rope, or any other rope known in the art. When in use, grid 20 may be suspended by rope 32. When not in use, grid 20 may be pulled up to bottom portion 18, or pulled forward or rearward, and affixed against vehicle 10. It is also contemplated that, when not in use, grid 20 may be removed and affixed against right side 25, left side 25′, top 22, or rear 16 of vehicle 10. In this manner, rope 32 may be used for this purpose, using, e.g. pulleys (not shown). It is also contemplated that grid 20 may be more rigidly suspended from bottom portion 18 by way of a bar or plurality of bars (not shown) constructed of material similar to grid 20. Grid 20 may be connected to vehicle 10 by any other way known in the art. The plurality of slats 26 may be connected to one another by way of one or more bars 34. Each bar 34 may be any shape, for instance each bar 34 may be rectangular or triangle shaped, with a corner of the rectangle or triangle oriented toward the ground. Bar 34 may be any shape known in the art. FIG. 3 depicts grid 20 including two bars 34, however it is contemplated that grid 20 may include any number of bars 34. It is further contemplated that bars 34 may be omitted and slats 26 may be connected by frame 29.

FIG. 2 depicts slats 26 oriented at angles 26a and 26b relative to the surface of the ground. In the configurations depicted in FIG. 2, angles 26a and 26b are each about 60 degrees relative to the ground but opposed relative to the vehicle centerline. Any angle less than about 90 degrees relative to the ground may provide the benefit of deflecting the ejecta away from vehicle 10, and would absorb and dissipate a portion of the impulse resulting in the momentum change of the ejecta hitting grid 20 instead of bottom portion 18. Angles above about 45 degrees relative to the ground may be more effective at preventing the impulse transfer to bottom portion 18. Also, increasing the angle of slats 26 relative to the ground, may require more and/or wider slats 26 to provide adequate coverage of bottom portion 18, and may subsequently result in more weight. Angles below about 45 degrees relative to the ground may be less effective at preventing the impulse transfer to bottom portion 18. Also, reducing the angle of slats 26 relative to the ground may require less and/or narrower slats 26 to provide adequate coverage of bottom portion 18, and may subsequently result in less weight. The exact angle chosen may be dependent on a number of factors, including, but not limited to, the desired weight of grid 20, the desired weight of vehicle 10, and the configuration of bottom portion 18. By way of example, the angle of slats 26 may be chosen to equal an angle of bottom portion 18, alternatively the angle of slats 26 may be greater or less than an angle of bottom portion 18. Also, angles 26a and 26b depicted in FIG. 2 are equal, but need not be.

While FIGS. 1-8 and 11 depict the various slats and/or vanes oriented longitudinally with respect to centerline 27, it in contemplated that they may alternatively be arranged transversely with respect to centerline 27, or in a combination of the two, or any orientation relative to the centerline. By way of example, grid 20 may comprise three sections: a rear section including a plurality of slats 26 arranged transversely with respect to centerline 27 and configured to direct ejecta in a rearward direction; a middle section including a plurality of slats 26 arranged longitudinally with respect to centerline 27 and configured similar to grid 20 as depicted in FIGS. 1-8 and 11; and a front section including a plurality of slats 26 arranged transversely with respect to centerline 27 and configured to direct ejecta in a forward direction. The orientation or combination of orientations may be dependent on the configuration of bottom portion 18 of vehicle 10.

When a mine explodes below vehicle 10, soil ejecta may be launched in streams straight up into contact with grid 20. When the soil ejecta contacts a slat 26 of grid 20, it may be redirected and then into contact with bottom portion 20, or away from vehicle 10. The impulse of the explosion is transferred from the ejecta to grid 20 as the ejecta hits grid 20. Any ejecta that is not redirected away from vehicle 10, but instead into contact bottom portion 18, will have much less effect on bottom portion 18. Additionally, a stream of soil ejecta that is directed into contact with another stream of soil ejecta may form a hot spot where they contact one another. These “hot spots” may be extremely high temperatures, such as, for example, above 1600 degrees Celsius. Slats 26 may be configured to cause the hotspots to occur away from bottom portion 18 and further prevent damage. The transfer of momentum may cause grid 20 to deform, otherwise move, and impact bottom portion 18. In this manner, the impact is distributed amongst the bottom portion 18. Bottom portion 18 may then be configured to withstand the impact of grid 20.

In accordance with the invention, grid 20 may be located any distance above the surface of the land on which the vehicle operates. As here embodied, and with continued reference to FIG. 2, the vehicle 10 has a ground clearance (the distance above surface of the land on which the vehicle operates) as measured from the lowest extremity of the grid 20 of the vehicle 10. However, as discussed previously, because the unobstructed dissipation of the soil ejecta is minimal, and because the angle of slats 26 of grid 20 cause the blast energy and material to be directed away from bottom portion 18 of vehicle 10, the ground clearance of vehicle 10 may have a less significant affect on the effect of the blast energy and material. Because the ground clearance of vehicle 10 may be reduced, the overall center of gravity of vehicle 10 may be reduced. By reducing the center of gravity of vehicle 10, the stability of vehicle may be increased and the vehicle may have a reduced risk of rollover if turned at too sharp a radius and/or at too high a speed. In this manner, the determinative factor for the ground clearance of vehicle 10 is the operational parameters of vehicle 10, such as, for example, minimum ground clearance required to traverse the specific environment in which vehicle 10 operates.

Grid 20 may be particularly advantageous because it allows a low ground clearance, low ride height, and sharper angled slats (i.e. greater slat angles relative to the ground). Dash line A in FIG. 2 depicts approximately where bottom portion 18 would extend to if it had a 60 degree included angle (corresponding geometrically to a 60 degree angle between each side of the V and the ground. As can be seen by comparing the location of grid 20 to dash line A, grid 20 having 60 degree oriented slats 26 allows vehicle 10 to have a lower ride height, while still have sufficient operational ground clearance.

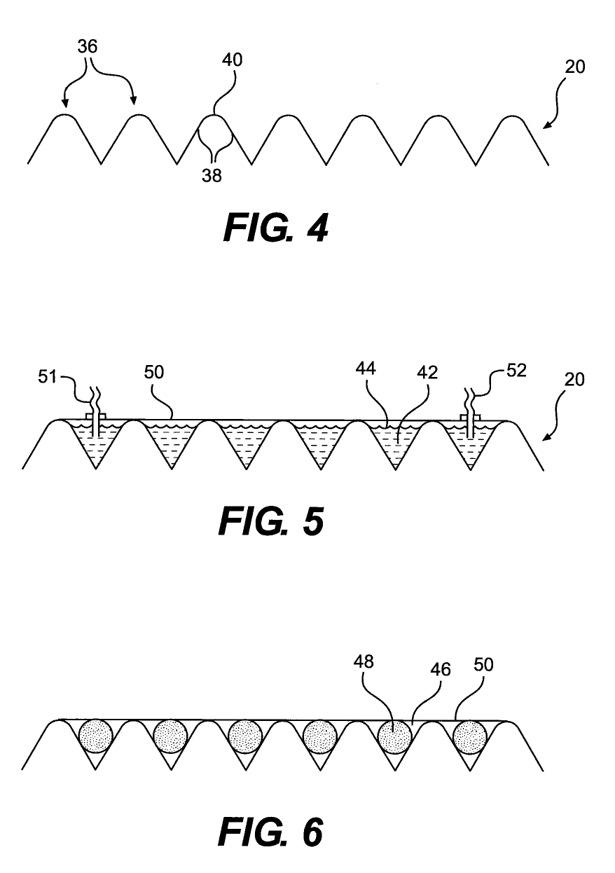

As depicted in FIGS. 4-6, grid 20 may alternatively include a plurality of vanes 36. Each vane 36 may define a V, with the apex of the V being rounded and directed towards bottom portion 18. The rounded top may have a radius of curvature of less than 100 millimeters. The included angle of the V-shaped vane 36 may be less than 90 degrees, specifically less than 70 degrees. When a stream of ejecta contacts a first side 38 of vane 36, it is directed to apex 40. The redirected ejecta then contacts ejecta from the opposing side 38 of vane 36 causing a “hot spot” to form at apex 40. These “hot spots” may be extremely high temperatures, such as, for example, above 1600 degrees Celsius and may cause damage to, or failure of, grid 20. In this manner, the hot spots may be formed away from bottom portion 18. Additionally, grid 20 may be propelled upward into bottom portion 18. In this manner, grid 20 sustains much of the damage from the mine blast, while bottom portion 18 primarily must absorb only the impact of grid 20 into bottom portion 18.

As depicted in FIGS. 5 and 6, the side of grid 20 facing bottom portion 18, may be filled with liquid, sand, pipes filled with sand, or any other energy absorbing substance known in the art. Specifically, FIG. 5 depicts an open space 42 filled with a liquid 44. Liquid 44 may be any liquid, such as, for example, water, or antifreeze. It is contemplated that open space 42 may also be filled with sand. In this manner, when a blast occurs below vehicle 10 the energy caused by the blast forces grid 20 into the energy absorbing substance, in this case, liquid 44 or sand. The inertia effect of the blast contacting grid 20 and then grid 20 subsequently being directed into the energy-absorbing substance, causes the effective weight of the energy-absorbing substance to be significantly higher than the actual weight. During the blast, the energy-absorbing substance is held in place by its own inertia. Grid 20 may also be fitted with a cover 50 to prevent the energy absorbing substance from shifting and/or spilling during operation of vehicle 10. Frame 29 depicted in FIGS. 2 and 3 also may prevent the energy absorbing substance from shifting and/or spilling during operation of vehicle 10.

As described above, hot spots may be formed at apex 40. When open space 42 contains liquid 44, the latent heat of evaporation of liquid 44 may cause liquid 44 to absorb heat energy from hot spots that may form during a blast event. In this manner, less energy may be directed towards bottom portion 18. As depicted in FIG. 5, grid 20 may include a fluid inlet 51 and a fluid outlet 53. In this manner, grid 20 may be configured to act as a heat exchanger, i.e. a radiator, or alternatively, may serve as an active or storage tank for the liquid to be stored, e.g. water, including potable water.

Alternatively, FIG. 6 depicts at least one metal ceramic, reinforced rubber, or reinforced plastic pipe 46 filled with sand 48 acting as the energy absorbing substance. It is also contemplated that a pipe filled with fluid or an empty pipe may be used. Furthermore it is not necessary for the energy absorbing substance to be positively fixed to grid 20, the energy-absorbing substance may lay, or nest, within the V space 42 between the vanes 36. Grid 20 may also be fitted with cover 50 to prevent the energy absorbing substance from shifting and/or spilling during operation of vehicle 10, as in the configuration in FIG. 5. While pipe 46 is depicted as being circular, it is contemplated that any pipe shape would be suitable, such as, for example, rectangular pipe, triangular pipe specifically formed to lay flush in open V space 42, or any other pipe shape known in the art. The energy-absorbing substance should be formed in order to maximize surface area contact between the energy-absorbing substance and vanes 36.

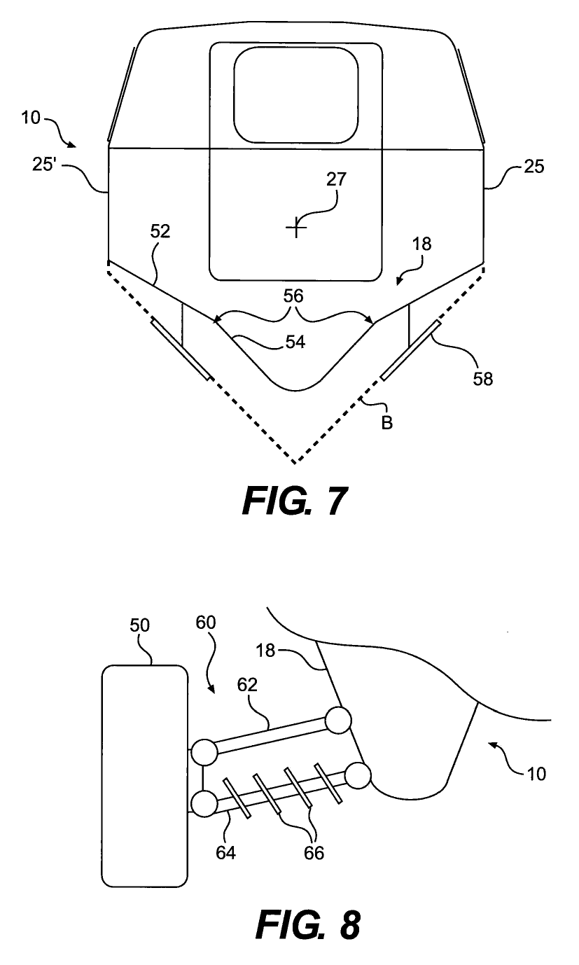

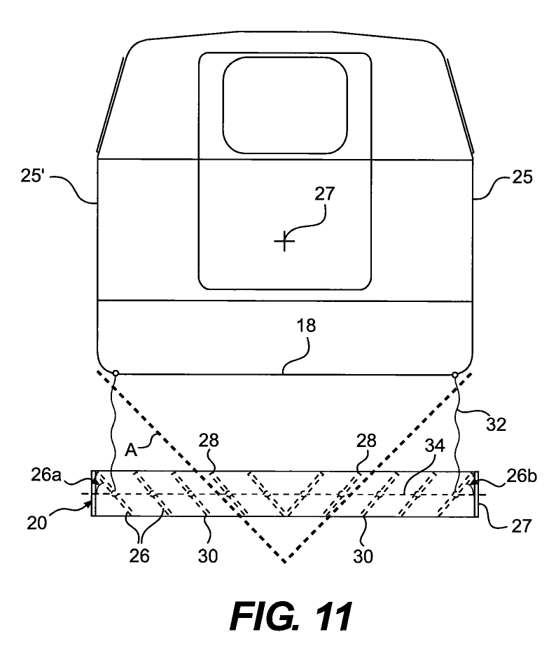

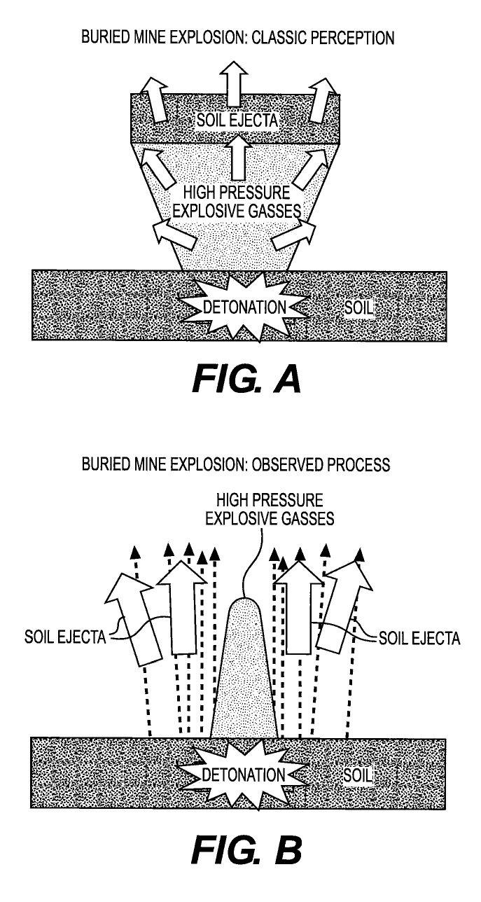

FIG. 7 depicts another embodiment of vehicle 10. Vehicle 10 is depicted as having bottom portion 18 with a compound V configuration including a first V section 52 having an included angle different from a second V section 54. FIG. 7 depicts first section 52 having an included angle greater than that of second section 54, but it is contemplated that section 54 may have a greater included angle than first section 52. It is further contemplated that bottom portion 18 may include a simple, single angle V as shown in FIG. 2, or flat, i.e. zero degree angle (FIG. 11). Vehicle 10 may have the configuration of FIG. 7 to allow a wider compartment area (not shown) for passengers, or a narrower bottom portion to accommodate engine and/or drive train components, while having the ejecta deflection benefits of the sharper angled first or second section. However, a compound angle bottom portion 18, such as depicted in FIG. 7 may have one or more weak points 56. Weak points 56 are caused by forming the compound angle from a single piece, or from the connection of the first section 52 and second section 54 by way of welding, riveting, bolting, or any other method of fixing two pieces together.

When ejecta contacts bottom portion 18, weak points 56 may be more negatively affected by the impulse as well as the heat generated by the contact. As depicted in FIG. 7, at least one slat 58 may be mounted on each side of centerline 27 of vehicle 10 and sized and oriented in such a way as to deflect ejecta away from weak points 56. Slat 58 may be oriented at any angle, less than 90 degrees relative to the surface of the ground. However, angles between about 80 degrees and about 30 degrees, more specifically between about 45 degrees and about 75 degrees, provide better deflection of ejecta, while still absorbing an adequate amount of the impulse. When the angle is less than 30 degrees, blast energy directed upward from beneath the vehicle will more efficiently transfer to the bottom portion of the vehicle. When the angle is greater than 80 degrees the deflection benefits may be decreased. In the embodiment depicted in FIG. 7, the angle of slat 58 may be such that it is substantially parallel to the adjacent portion of second section 54. The width of slat 58 may be selected in relation to the size of weak point 56. While FIG. 7 depicts one slat 58 on each side of centerline 27, it is contemplated that any number of slats 58 may be mounted to vehicle 10. Each slat 26 may extend the entire length of vehicle 10, it is contemplated that slats 58 may be a shorter length, such as, for example, may extend from front wheel 50 to rear wheel 52.

Slats 58 may be particularly advantageous because they allow a low ground clearance, low ride height, and the benefits of an angled bottom portion. Dash line B in FIG. 7 depicts approximately where bottom portion 18 would extend to if it were a simple V with a 60 degree included angle. As can be seen by comparing the location of slats 58 to dash line B, Slats 58 allow vehicle 10 to have a lower ride height, while still have sufficient operational ground clearance.

FIG. 8 depicts a portion of vehicle 10, specifically a suspension system 60. Suspension system 60 is depicted as an independent suspension, but it is contemplated that suspension system 60 may be partially independent, i.e. independent in front and rigid (not independent) in the rear, or may be fully rigid. Suspension system 60 may include an upper suspension arm 62 and lower suspension arm 64. Lower suspension arm 64 may include at least one slat 66. Slats 66 may be angled in a fashion similar to slats 26 and slat 58 as described above. While FIG. 8 depicts slats 66 mounted only on lower suspension arm 64 it is contemplated that slats 66 may be mounted on either or both of lower suspension arm 66 and upper suspension arm 62, and that there may be any number of slats 66. Slats 66 may be oriented to direct ejecta away from known weak spots (not shown) in suspension system 60 or purposefully generate hot spots away from critical components, as discussed previously. A hot spot may be generated by directing ejecta into another directed ejecta stream, or into an undirected ejecta stream.

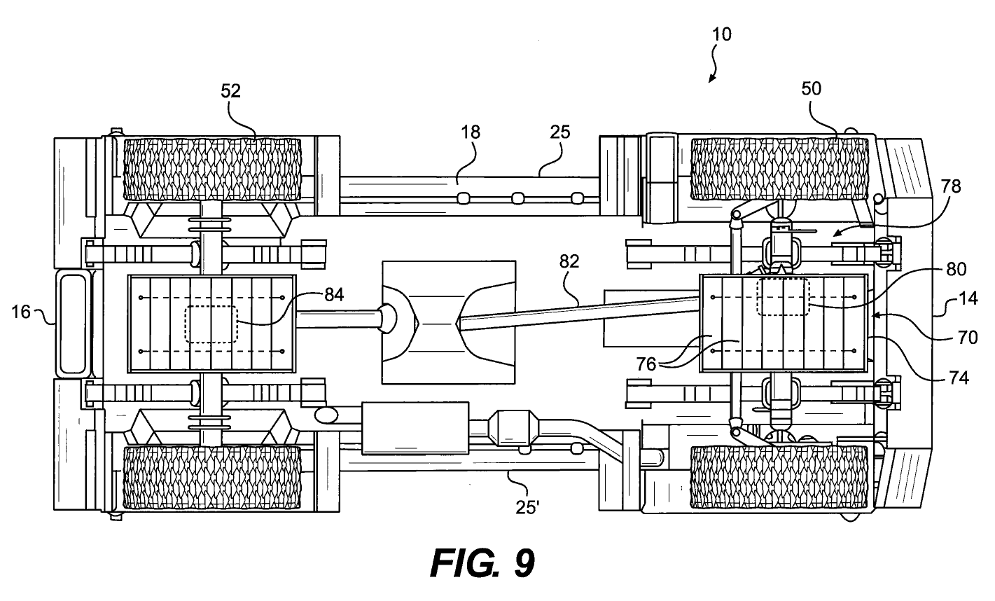

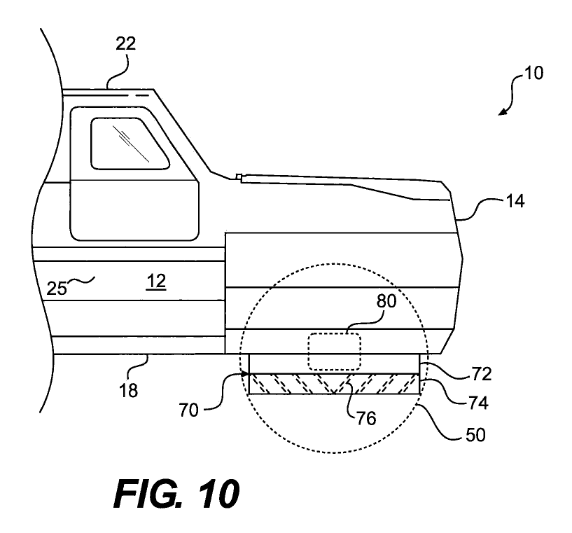

FIG. 9 depicts a portion of vehicle 10, specifically certain common automotive elements (“underbody elements”) of the underbody of vehicle 10. As shown in FIG. 9, vehicle 10 may include a suspension system 78, a front differential 80, drive shaft 82, and a rear differential 84. Certain of these underbody elements, such as, for example, front differential 80 and rear differential 84 may extend below bottom portion 18 and, due to their size and shape, may not be effective at preventing the impulse of a mine blast from transferring to bottom portion 18 of vehicle 10, resulting in damage to vehicle 10. Additionally, underbody elements may trap ejecta causing hot spots and further damage to vehicle 10. An underbody element, for example front differential 80, may include an armor system 70 configured to redirect ejecta and reduce the impulse transferred to vehicle 10 as well as reduce damage to vehicle 10 from hot spots. FIG. 10 depicts a side view of vehicle 10, specifically armor system 70 for protecting front differential 80. Armor system 70 may include an enclosure 72 (shown in FIG. 10) mounted to bottom portion 18, and a grid 74 having slats 76. Enclosure 72 may include a single material or combination of materials, including, but not limited to, fiber reinforced rubber, reinforced plastic, molded polyurethane, composites, metal, and metal alloy. The material used may be dependent on the anticipated threat and level of threat. Enclosure 72 may cover a portion of an underbody element. Grid 74 may be similar to grid 20 described above. It is also contemplated that armor system 70 may not include enclosure 72 and that grid 74 with slats 76 may be mounted directly to bottom portion 18. Grid 74 may be mounted to bottom portion 18 or enclosure 72 in a manner similar to that described for grid 20. As depicted in FIG. 10, slats 76 are shown arranged transverse with respect to centerline 27. It is contemplated that slats 76 may also be arranged longitudinally with respect to centerline 27. It is contemplated that armor system 70 may be suitable for protecting any underbody element known in the art, and is not limited to front differential 80 and rear differential 84.

Additionally, it is contemplated that an existing vehicle may be retrofitted with a grid 20 having slats 26, a set of vanes 36, individual slats 58, slats 66 or a grid 74 with slats 76 to gain the benefits described throughout by using an assemblage of required parts specific to the vehicle, e.g. in kit form including appropriate hardware such as mounting bars, chains or ropes, and/or fasteners.

As here embodied, and with reference to FIGS. 1-11, the vehicle 10 may be a 4×4 wheeled vehicle with an engine (not shown), detachably connected to the vehicle 10 within the front portion 14 of the body 12. The engine is preferably a diesel-cycle engine because of the normal advantages of diesel power for relatively heavy vehicles in addition to the fact that diesel fuel is relatively difficult to ignite by an explosive device penetrating the fuel tank. In a preferred embodiment, the engine may be a commercially available diesel engine, although an engine specially developed for the vehicle could be used. The use of a commercially available engine reduces the cost of the vehicle and simplifies the design and manufacturing process because the size and location of ancillary engine components (e.g., engine motor mounts, not shown) can be readily ascertained from the commercial application and engine installation publications available from the engine manufacturer. The engine cooling system, exhaust system and electrical system may be conventional. Additionally, any compatible transmission and suspension system may be used.

Other embodiments of the invention will be apparent to those skilled in the art from consideration of the specification and practice of the invention disclosed herein. Specifically, various combinations of the embodiments disclosed may be combined, such as, for example, the suspension may be useable with any bottom portion configuration, a grid with slats or a grid with vanes may be used with any configuration of bottom portion, and suspended slats may be used with any configuration of bottom portion. It is intended that the specification and examples be considered as exemplary only, with a true scope and spirit of the invention being indicated by the following claims.

What is claimed is:

1. A blast-resistant armored land vehicle configured to operate on a surface, comprising:
a body comprised of sheet materials, the body having a centerline and a bottom portion;
a grid portion suspended below the bottom portion, the grid portion including one or more slats on each side of the centerline, wherein the one or more slats are oriented at an angle less than 90 degrees relative to the surface.

2. The vehicle of claim 1, wherein the slats are oriented at an angle between about 30 degrees and about 80 degrees relative to the surface.

3. The vehicle of claim 1, wherein the one or more slats on each side of the centerline is a plurality of slats on each side of the centerline, and wherein the plurality of slats on one side of the centerline are generally parallel to one another and the plurality of slats on the other side of the centerline are generally parallel to one another.

4. A blast-resistant armored land vehicle configured to operate on a surface, comprising:
a body comprised of sheet materials, the body having a centerline and a bottom portion;
a grid portion suspended below the bottom portion, the grid portion including one or more vanes, each of the one of more vanes defining a V, with the apex of the V being rounded and directed towards the bottom portion.

5. The vehicle of claim 4, wherein the included angle of the V of each of the one or more vanes is less than about 90 degrees.

6. The vehicle of claim 4, wherein the one or more vanes is a plurality of interconnected vanes and wherein the plurality of interconnected vanes defines a plurality of open V shaped spaces above the grid portion.

7. The vehicle of claim 6, wherein the grid portion includes an energy-absorbing substance extending longitudinally along a top of the grid portion within the open V shaped spaces.

8. The vehicle of claim 7, wherein the energy-absorbing substance is at least one of water and antifreeze.

9. The vehicle of claim 8, further including a liquid-cooled engine, the engine in fluid communication with the grid.

10. The vehicle of claim 8, wherein the energy-absorbing substance is a pipe filled with sand.

11. The vehicle of claim 5, further including a suspension, the suspension including an upper suspension and a lower suspension arm, and wherein at least one of the lower suspension arm and the upper suspension arm includes at least one slat oriented at an angle less than 90 degrees relative the surface.

12. The vehicle of claim 5, further including an underbody element, wherein the underbody element includes a grid portion suspended below the underbody element, the grid portion including one or more slats, wherein the one or more slats are oriented at an angle less than 90 degrees relative to the surface.

13. A blast-resistant armored land vehicle configured to operate on a surface, comprising:
a body comprised of sheet materials, the body having a centerline and a bottom portion, the bottom portion defining at least one V, with the apex of the at least one V substantially parallel to the longitudinal centerline of the vehicle;
at least one pair of slats suspended from the bottom portion, wherein a first slat of the at least one pair in located on one side of the centerline and a second slat of the at least one pair is located on the other side of the centerline, and wherein the first and second slats of the at least one pair of slats is oriented at an angle less than about 90 degrees relative to the surface.

14. The vehicle of claim 13, wherein each of the first and second slats of the at least one pair of slats is oriented at an angle less than about 70 degrees relative to the surface.

15. The vehicle of claim 13, wherein the first slat and the second slat are oriented at substantially the same and opposing angles.

16. The vehicle of claim 13, wherein each of the first and second slats of the at least one pair of slats are oriented at an angle substantially parallel to, and adjacent part of, the bottom portion.

17. The vehicle of claim 13, wherein the bottom portion defines two Vs and wherein the two Vs intersect at a first point on one side of the centerline and a second point on the other side of the centerline.

18. The vehicle of claim 17, wherein the first slat is suspended directly below the first point and wherein the second slat is suspended directly below the second point.

19. A kit for retrofitting a mine blast resistant vehicle, the vehicle having a bottom portion and configured to ride on a surface, the kit including:
a grid including one or more slats on each side of the centerline, wherein the one or more slats are oriented at an angle less than 90 degrees relative to the surface; and
means for suspending the grid beneath the bottom portion.

20. A kit for retrofitting a mine blast resistant vehicle, the vehicle having a bottom portion and configured to ride on a surface, the kit including:
a grid including one or more vanes, each of the one of more vanes defining a V, with the apex of the V being rounded and directed towards the bottom portion; and
means for suspending the grid beneath the bottom portion.
